(19) United States
(12) Patent Application Publication
(10) Pub. No.: US 2005/0237738 A1
(43) Pub. Date: Oct. 27, 2005

(54) Flashlight

(76) Inventor: Wen-Chin Shiau, Tao-Yuan Hsien (TW)

Correspondence Address: FROMMER LAWRENCE & HAUG, 745 FIFTH AVENUE- 10TH FL., NEW YORK, NY, 10151, US

(21) Appl. No.: 10/871,810

(22) Filed: Jun. 18, 2004

(30) Foreign Application Priority Data
Apr. 26, 2004 (TW) 93111549

(51) Int. Cl. F21L 4/00

(52) U.S. Cl. 362/202

(57) ABSTRACT

A flashlight includes a conductive casing, a lamp seat holder, a reflector, a dielectric body, and a lamp seat. The lamp seat holder defines a receiving space, and has an inner end inserted into one end of the casing and an outer end extending outwardly from the casing. The reflector has one end inserted threadedly into the outer end of the lamp seat holder. The dielectric body is fitted in the inner end of the lamp seat holder, and holds a pair of electrode elements. The lamp seat is disposed within the lamp seat holder between the dielectric body and the reflector.

### CROSS-REFERENCE TO RELATED APPLICATION

This application claims priority of Taiwanese Application No. 093111549, filed on Apr. 26, 2004.

### BACKGROUND OF THE INVENTION

1. Field of the Invention

The invention relates to a flashlight, more particularly to a flashlight that can accommodate different constructions of lamp seats for holding different lamp units.

2. Description of the Related Art

Referring to FIG. 1, a conventional flashlight 100 includes a tubular body 11 and a lamp cover 13. The tubular body 11 has an inner portion for receiving a battery unit 15 therein, and has a first end connected to a biasing unit (not shown) for biasing the battery unit 15. The lamp cover 13 covers a second end of the tubular body 11, and cooperates with the tubular body 11 to define therebetween a receiving space 17 for receiving a lamp seat 14 therein. The lamp seat 14 accommodates a lamp unit 18 having two pins 181, 183. The lamp seat 14 includes a base seat 140 and a reflector 141. The base seat 140 is disposed on an inner wall surface of the second end of the tubular body 11, and has two terminals 143, 144. When the lamp unit 18 is inserted into the lamp seat 14, the pins 181, 183 of the lamp unit 18 are respectively and electrically coupled to the terminals 143, 144 of the lamp seat 14. At the same time, one of the terminals 143 is electrically coupled to a first electrode of the battery 15, while the other one of the terminals 144 is electrically coupled to the inner wall surface of the tubular body 11. Because the tubular body 11 is made of a conductive material, the terminal 144 is indirectly electrically coupled to a second electrode of the battery 15. This completes the circuit and the lamp unit 18 is thereby activated. The reflector 141 magnifies the intensity of the light generated by the lamp unit 18.

Since the lamp seat 14 is usually connected to the inner wall surface of the tubular body 11 by means of an adhesive or by welding, the lamp seat 14 cannot be detached from the tubular body 11. Therefore, the conventional flashlight 100 is restricted in the type of lamp unit that it may accommodate. In particular, it is necessary to use the above structure of the lamp unit 18 with the pins 181, 183.

If it is desired to alter the lamp unit 18 of the conventional flashlight 100, the lamp seat 14 has to be redesigned, a new mold has to be provided, and even the tubular body 11 and the lamp cover 13 have to be modified, thereby increasing production costs.

### SUMMARY OF THE INVENTION

Therefore, the object of the present invention is to provide a flashlight with an improved construction that permits interchanging of lamp seats with differing configurations.

According to this invention, a flashlight comprises a conductive casing, a lamp seat holder, a reflector, a dielectric body, and a lamp seat. The lamp seat holder defines a receiving space, and has an inner end inserted into one end of the casing and an outer end extending outwardly from the casing. The reflector has one end inserted threadedly in the outer end of the lamp seat holder. The dielectric body is fitted in the inner end of the lamp seat holder, and holds a pair of electrode elements. The lamp seat is disposed within the lamp seat holder between the dielectric body and the reflector.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary sectional view of a conventional flashlight;

FIG. 2 is an exploded perspective view of the preferred embodiment of a flashlight according to the present invention;

FIG. 3 is an assembled perspective view to illustrate a reflector and a lamp seat holder of the preferred embodiment;

FIG. 4 is an assembled sectional view of FIG. 2;

FIG. 5 is a sectional view of an alternative lamp unit applicable to the preferred embodiment; and

FIG. 6 is a sectional view of another alternative lamp unit applicable to the preferred embodiment.

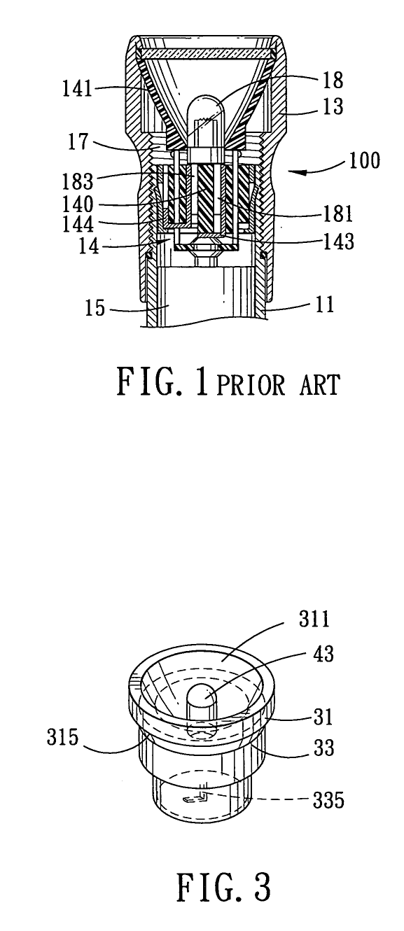

### DETAILED DESCRIPTION OF THE PREFERRED EMBODIMENT

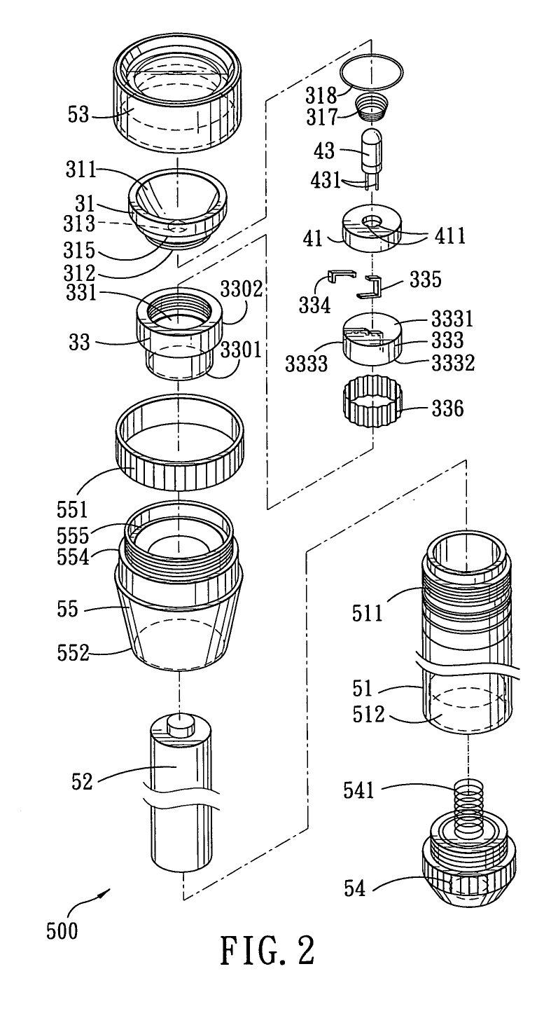

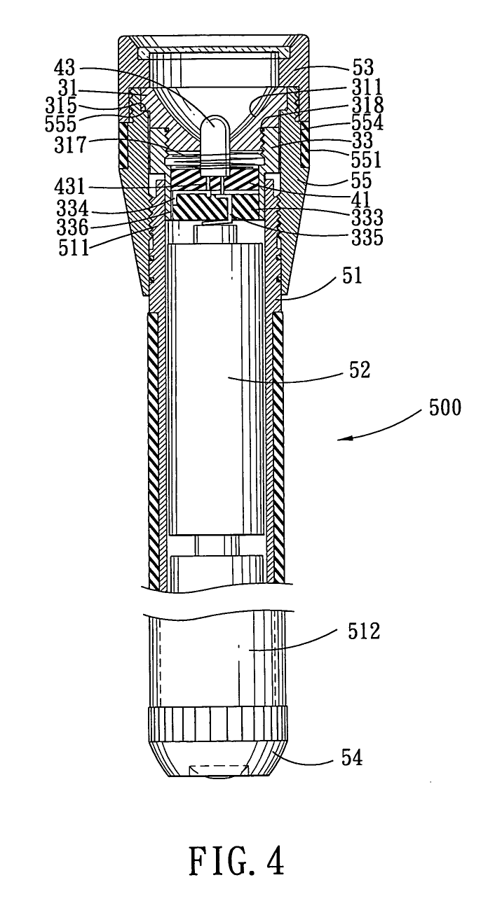

Referring to FIGS. 2 to 4, the preferred embodiment of a flashlight 500 according to the present invention is shown to comprise a conductive casing 51, a cap 53, a lamp seat holder 33, a reflector 31, a dielectric body 333, and a lamp seat 41.

The conductive casing 51 is cylindrical, and has an externally threaded front end 511 and an internally threaded rear end 512. An inner chamber of the casing 51 is used for receiving at least one battery 52.

A hollow coupling member 55 has a first part 552 sleeved around and engaging threadedly the front end 511 of the casing 51, and a second part 554 opposite to the first part 552. The second part 554 has an annular shoulder 555 formed on an inner wall surface of the coupling member 55. An anti-slip rubber ring 551 is sleeved on the coupling member 55 proximate to the second part 554.

The cap 53 is sleeved around and engages threadedly the second part 554 of the coupling member 55.

A rear cover 54 is connected threadedly to the rear end 512 of the casing 51, and has a spring member 541 extending into the inner chamber of the casing 51. The spring member 541 has one end in contact with an end of the battery 52 so as to bias the battery 52 towards the front end 511 of the casing 51 and so as to establish an electrical connection among the rear cover 54, the casing 51, the coupling member 55, and an electrode of the battery 52. The rear cover 54 may also be provided with a switch unit (not shown) for activating or deactivating electrical connections between the casing 51 and the electrode of the battery 52.

The lamp seat holder 33 defines a receiving space 331, and has an inner end 3301 inserted into the front end 511 of the casing 51, and an outer end 3302 extending outwardly from the casing 51.

The reflector 31 has one end 312 inserted threadedly into the outer end 3302 of the lamp seat holder 33, and the other end provided with a semi-spherical reflector lens 311. The reflector lens 311 has a central portion formed with a through hole 313 that is in spatial communication with the receiving space 331 in the lamp seat holder 33. An outer wall surface of the reflector 31 is formed with an annular protrusion 315 that abuts against the shoulder 555 of the coupling member 55. In this embodiment, a rubber packing ring 318 is disposed between the reflector 31 and the lamp seat holder 33 to serve as a buffer. The second part 554 of the coupling member 55 is sleeved around the lamp seat holder 33 and the reflector 31.

The dielectric body 333 is fitted in the inner end 3301 of the lamp seat holder 33, and holds a pair of electrode elements 334, 335. The dielectric body 333 has opposite first and second sides 3331, 3332, and a lateral side 3333 interconnecting the first and second sides 3331, 3332. The electrode element 335 extends through the dielectric body 333, and has two end parts exposed from the first and second sides 3331, 3332, respectively. The electrode element 334 extends from the first side 3331 to the lateral side 3333.

A conductive engaging ring 336 is disposed between the lateral side 3333 of the dielectric body 333 and an inner wall surface of the lamp seat holder 33 so as to tightly position the dielectric body 333 within the receiving space 331 of the lamp seat holder 33. The engaging ring 336 is in contact with the electrode element 334 so that the latter is coupled electrically to the lamp seat holder 33 and the reflector 31. In this embodiment, the engaging ring 336 is corrugated and resilient.

The lamp seat 41 is disposed within the receiving space 331 formed in the lamp seat holder 33 between the dielectric body 333 and the reflector 31. The first side 3331 of the dielectric body 333 faces the lamp seat 41. Through clamping action of the dielectric body 333 and the reflector 31, the lamp seat 41 is stably positioned within the lamp seat holder 33. The lamp seat 41 is formed with two insert holes 411 extending through two opposite end faces thereof.

A lamp unit 43 is mounted on the lamp seat 41, and has two pins 431 respectively inserted through the insert holes 411 and coupled to the electrode elements 334, 335. The lamp unit 43 extends through the through hole 313 in the reflector 31 so as to be surrounded by the reflector lens 311. Because the reflector 31 and the lamp seat holder 33 are interconnected threadedly, the degree of threaded engagement between the reflector 31 and the lamp seat holder 33 will affect the level of protrusion of the lamp unit 43 into the reflector lens 311. That is, when the reflector 31 is tightly screwed onto the lamp seat holder 33, the lamp unit 43 will project more into the reflector lens 311, whereas the lamp unit 43 will project slightly into the reflector lens 311 if these elements are only partially threadedly engaged. In this embodiment, it is not necessary to fully engage the reflector 31 onto the lamp seat holder 33, and the degree of threaded engagement may be decided upon by the user.

A coiled spring 317 may be added between the lamp seat 41 and the reflector 31. The coiled spring 317 biases the lamp seat 41 towards the dielectric body 333 so as to ensure electrical connections between the pins 431 and the electrode elements 334, 335.

The lamp seat holder 33, the dielectric body 333 with the electrode elements 334, 335, the conductive engaging ring 336, the lamp seat 41, the lamp unit 43, the coiled spring 317, the packing ring 318, and the reflector 31 are pre-assembled to form a module, as best shown in FIG. 3.

During assembly, the coupling member 55 is first mounted on the front end 511 of the casing 51, followed by the insertion of the aforesaid pre-assembled components into the casing 51. The annular protrusion 315 of the reflector 31 abuts against the shoulder 555 of the coupling member 55 at this time. Next, the cap 53 is placed covering the coupling member 55. The cap 53 and the coupling member 55 cooperate to clamp therebetween the reflector 31 so as to position the reflector 31. The electrode element 335 abuts against one of the electrodes of the battery 52 after assembly, and through the biasing force of the spring member 541, the battery 52 and the electrode element 335 are maintained in a stable contact. Thus, one of the electrodes of the battery 52 is coupled to one of the pins 431 of the lamp unit 43 through the spring member 541, the rear cover 54, the casing 51, the coupling member 55, the reflector cap 31, the lamp seat holder 33, the engaging ring 336, and the electrode element 334. The other one of the electrodes of the battery 52 is coupled to the other one of the pins 431 of the lamp unit 43 through the electrode element 335 so as to activate the lamp unit 43.

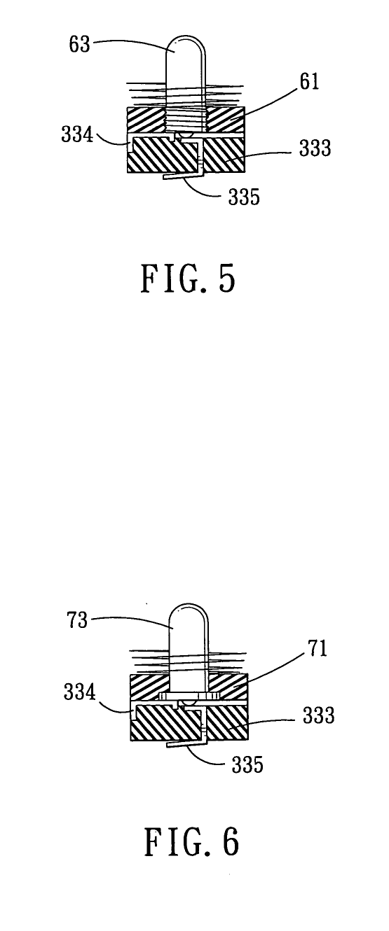

According to the present invention, the lamp unit 43 of the flashlight 500 may be replaced with a different lamp unit 63 shown in FIG. 5, or another lamp unit 73 shown in FIG. 6. The lamp unit 63 is a screw-type device, whereas the lamp unit 73 is a contact-type device. Because each of the lamp units 63, 73 is known in the art, a detailed description of the same will be dispensed herewith. As illustrated in FIG. 5, the electrodes of the lamp unit 63 contact respectively the electrode elements 334, 335 of the dielectric body 333 after assembly. In this case, a corresponding lamp seat 61 is used. As illustrated in FIG. 6, the electrodes of the lamp unit 73 contact respectively the electrode elements 334, 335 of the dielectric body 333 after assembly. A corresponding lamp seat 71 is also used in this case. Therefore, only the lamp seat 61, 71 needs to be modified for replacement. Hence, the flashlight 500 of the present invention can accommodate different kinds of lamp units without the need to redesign the whole structure and to prepare new molds, thereby minimizing production costs.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A flashlight comprising:
a conductive casing;
a lamp seat holder defining a receiving space and having an inner end inserted into one end of said casing and an outer end extending outwardly from said casing;
a reflector having one end inserted threadedly into said outer end of said lamp seat holder;
a dielectric body fitted in said inner end of said lamp seat holder and holding a pair of electrode elements; and
a lamp seat disposed within said lamp seat holder between said dielectric body and said reflector.

2. The flashlight as claimed in claim 1, wherein said dielectric body includes a first side facing said lamp seat, a second side opposite to said first side, and a lateral side interconnecting said first and second sides.

3. The flashlight as claimed in claim 2, wherein one of said electrode elements extends through said dielectric body, and has two end parts exposed from said first and second sides, respectively, the other one of said electrode elements extending from said first side to said lateral side.

4. The flashlight as claimed in claim 1, wherein said lamp seat holder further includes a conductive engaging ring disposed between said lateral side of said dielectric body and an inner wall surface of said lamp seat holder, said engaging ring being corrugated and resilient.

5. The flashlight as claimed in claim 1, further comprising a coiled spring disposed between said reflector and said lamp seat.

6. The flashlight as claimed in claim 1, further comprising a hollow coupling member having a first part sleeved around and engaging threadedly said casing, and a second part sleeved around said lamp seat holder and said reflector.

7. The flashlight as claimed in claim 6, further comprising a cap sleeved around and engaging threadedly said second part of said coupling member.
